(19) United States
(12) Patent Application Publication
(10) Pub. No.: US 2025/0097191 A1
(43) Pub. Date: Mar. 20, 2025

(54) NETWORK SYSTEM

(71) Applicant: FUJIFILM Business Innovation Corp., Tokyo (JP)

(72) Inventor: Takashi KOMATSU, Kanagawa (JP)

(73) Assignee: FUJIFILM Business Innovation Corp., Tokyo (JP)

(21) Appl. No.: 18/594,935

(22) Filed: Mar. 4, 2024

(30) Foreign Application Priority Data
Sep. 14, 2023 (JP) 2023-149353

(51) Int. Cl. H04L 61/4541; H04L 9/40

(52) U.S. Cl. CPC H04L 61/4541; H04L 63/0876

(57) ABSTRACT

A network system includes a recording unit that is disposed on a network and in which recording information that includes address information, first affiliation information, and second affiliation information of a plurality of information devices is recorded, and a processor configured to execute, when an inquiry about an information device usable by a search terminal is received from the search terminal, a returning operation of extracting address information of the information device that has same first affiliation information as the search terminal from the recording unit and returning the address information, and execute a supplementing operation of supplementing, for a first information device for which there is no first affiliation information in recording information, the recording information of the first information device with the first affiliation information based on recording information of a second information device that has same second affiliation information as the first information device. In the returning operation, the processor is configured to extract address information of an information device that has the same first affiliation information based on information of the recording unit that reflects a result of supplementation by the supplementing operation and returns the address information.

### CROSS-REFERENCE TO RELATED APPLICATIONS

This application is based on and claims priority under 35 USC 119 from Japanese Patent Application No. 2023-149353 filed Sep. 14, 2023.

### BACKGROUND

### (i) Technical Field

The present disclosure relates to a network system.

### (ii) Related Art

For example, a network system in Japanese Unexamined Patent Application Publication No. 2016-019222 includes a wireless local area network (LAN) access point device, a management device, and a server device. Disclosed is a network system in which a management device stores a first Internet Protocol (IP) address and identification information in association with each other and transmits the first IP address and the identification information to a server device, the server device stores the first TP address and the identification information in association with each other, a wireless LAN access point device transmits a second IP address and identification information to the server device, the server device stores the second IP address and the identification information in association with each other, and the management device acquires the identification information and the second IP address and establishes a virtual private network (VPN) with the wireless LAN access point device by using the second IP address when the acquired identification information matches the identification information stored in association with the first IP address.

### SUMMARY

Aspects of non-limiting embodiments of the present disclosure relate to a technique that enables a search terminal having the same affiliation information to refer to an information device for which affiliation information is not included in recording information. Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a network system including a recording unit that is disposed on a network and in which recording information that includes address information, first affiliation information, and second affiliation information of a plurality of information devices is recorded, and a processor configured to execute, when an inquiry about an information device usable by a search terminal is received from the search terminal, a returning operation of extracting address information of the information device that has same first affiliation information as the search terminal from the recording unit and returning the address information, and execute a supplementing operation of supplementing, for a first information device for which there is no first affiliation information in recording information, the recording information of the first information device with the first affiliation information based on recording information of a second information device that has same second affiliation information as the first information device, in which in the returning operation, the processor is configured to extract address information of an information device that has the same first affiliation information based on information of the recording unit that reflects a result of supplementation by the supplementing operation and returns the address information.

### BRIEF DESCRIPTION OF THE DRAWINGS

Exemplary embodiments of the present disclosure will be described in detail based on the following figures, wherein:

FIG. 1 is a diagram for explanation of a network system according to a first exemplary embodiment of the present disclosure;

FIG. 2 is a diagram illustrating a list of information devices recorded in a recording unit according to the first exemplary embodiment of the present disclosure;

FIG. 3 is a flowchart illustrating a returning operation according to the first exemplary embodiment of the present disclosure;

FIG. 4 is a diagram for explanation of a result of extracting address information of information devices for which an item of owner is the same as that for a search terminal out of the list of information devices illustrated in FIG. 2;

FIG. 5 is a flowchart illustrating a supplementing operation according to the first exemplary embodiment of the present disclosure;

FIG. 6 is a diagram for explanation of the supplementing operation according to the first exemplary embodiment of the present disclosure, and is a diagram illustrating a result of extracting a list of information devices whose network information is the same as that of the search terminal;

FIG. 7 is a diagram illustrating a result of supplementation of the item of owner of an information device for which the item of owner is unentered, based on the content of the item of owner of an information device for which the item of owner is entered, among the information devices illustrated in FIG. 6;

FIG. 8 is a diagram illustrating a list of information devices recorded in the recording unit supplemented by the supplementing operation according to the first exemplary embodiment of the present disclosure;

FIG. 9 is a diagram for explanation of a result of extracting the address information of information devices for which the item of owner is the same as that for the search terminal out of the list of information devices illustrated in FIG. 8;

FIG. 10 is a diagram illustrating a list of information devices recorded in a recording unit according to a second exemplary embodiment of the present disclosure;

FIG. 11 is a diagram illustrating information of a search terminal according to the second exemplary embodiment of the present disclosure;

FIG. 12 is a flowchart illustrating a supplementing operation according to the second exemplary embodiment of the present disclosure;

FIG. 13 is a diagram for explanation of the supplementing operation according to the second exemplary embodiment of the present disclosure, and is a diagram illustrating a result of extracting a list of information devices having the same network information;

FIG. 14 is a diagram illustrating a result of supplementing, based on the content of an item of office name of an information device for which the item of office name is entered, an item of floor information of an information device for which the item of floor information is unentered, among information devices whose network information is the same as that of the search terminal, in the diagram illustrated in FIG. 12;

FIG. 15 is a diagram illustrating a list of information devices recorded in the recording unit supplemented by the supplementing operation according to the second exemplary embodiment of the present disclosure;

FIG. 16 is a diagram for explanation of a result of extracting the address information of information devices for which the item of office name is the same as that for the search terminal out of the list of information devices illustrated in FIG. 15;

FIG. 17 is a diagram illustrating a list of information devices recorded in a recording unit according to a third exemplary embodiment of the present disclosure;

FIG. 18 is a diagram for explanation of a result of extracting and supplementing the address information of information devices for which an item of authentication server is the same as that for the search terminal out of the list of information devices illustrated in FIG. 17;

FIG. 19 is a diagram illustrating a list of a result of extracting, from the recording unit in which information devices supplemented by a supplementing operation according to the third exemplary embodiment of the present disclosure are recorded, the address information of usable information devices and then re-extracting information devices for which the office name satisfies a specified condition; and

FIG. 20 is a diagram illustrating an access route from an information device to a cloud server recorded in a recording unit according to a fourth exemplary embodiment of the present disclosure.

### DETAILED DESCRIPTION

Hereinafter, an example of exemplary embodiments of the present disclosure will be described with reference to the drawings. Note that in the drawings, the same or equivalent constituent elements and parts are denoted by the same reference signs.

### First Exemplary Embodiment

### Configuration

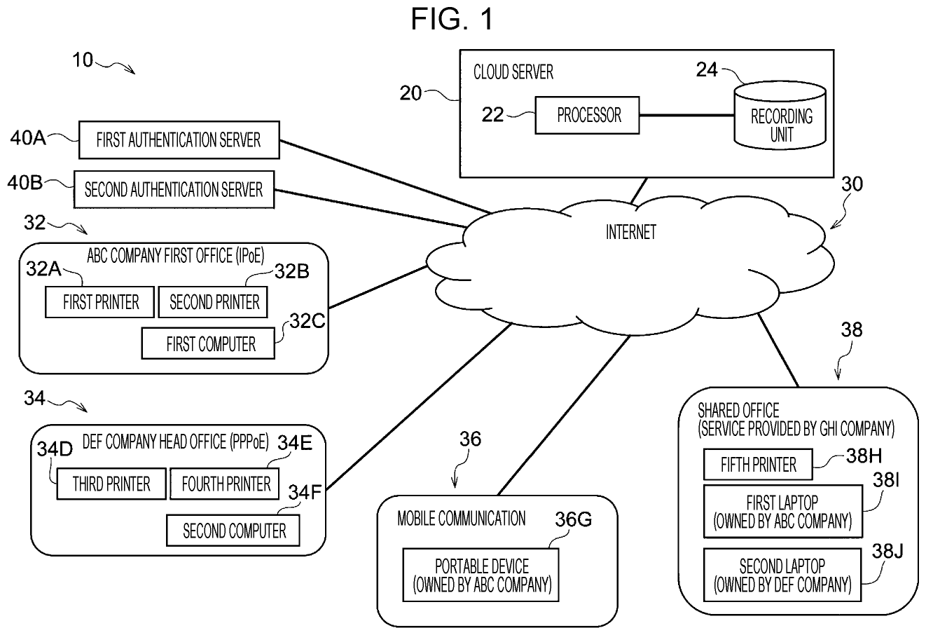

A network system 10 according to a first exemplary embodiment of the present disclosure will be described with reference to FIGS. 1 to 9 as appropriate.

FIG. 1 is a diagram illustrating the network system 10 according to the present exemplary embodiment. As illustrated in FIG. 1, the network system 10 according to the present exemplary embodiment includes a plurality of small-scale networks, a first authentication server 40A, a second authentication server 40B, and a cloud server 20 that are connected to Internet 30.

### Small-Scale Networks

As illustrated in FIG. 1, the small-scale networks are connected to the Internet 30 on a network-by-network basis. In the present exemplary embodiment, an example in which a first network 32, a second network 34, a third network 36, and a fourth network 38 are provided will be described as an example.

The first network 32 is a network to which information devices including a first printer 32A, a second printer 32B, and a first computer 32C are connected. The first printer 32A and the second printer 32B are information devices that, when a print job is received from another information device including the first computer 32C, print an image in accordance with the print job.

The first network 32 is a local area network (LAN) to which a plurality of information devices are connected, and each information device is connected via a router (not illustrated) constituting the LAN. Note that the first network 32 adopts the internet protocol over Ethernet (IPoE) method, and each information device connected to the first network 32 is directly connected to the Internet 30. Further, each information device connected to the first network 32 is connected to the Internet 30 by the Internet protocol version 6 (IPv6) method, and as will be described later, an IPv6 address is individually assigned to each information device as viewed from the Internet 30.

Note that, in the following description, a provider of the first network 32 is referred to as “ABC company”. Further, in the present description, all of the information devices connected to the first network 32 are information devices owned by ABC company.

The second network 34 is a network to which information devices including a third printer 34D, a fourth printer 34E, and a second computer 34F are connected. The third printer 34D and the fourth printer 34E are information devices that, when a print job is received from another information device including the second computer 34F, print an image in accordance with the print job.

The second network 34 is also a LAN to which a plurality of information devices are connected, and each information device is connected via a router (not illustrated) constituting the LAN. Note that the second network 34 adopts the point-to-point protocol over Ethernet (PPPoE) method, and each information device connected to the second network 34 is indirectly connected to the Internet 30 via the router. Further, each information device connected to the second network 34 is connected by the Internet protocol version 4 (IPv4) method, and only the IP address (IPv4 WAN address) of the router can be referred to from the Internet 30. Further, an IP address is individually assigned to each information device connected to the second network 34 inside the second network 34.

Note that, in the following description, a provider of the second network 34 is referred to as “DEF company”. Further, in the present description, all of the information devices connected to the second network 34 are information devices owned by DEF company.

The third network 36 is a network to which information devices including a portable device 36G are connected. The portable device 36G is an information device capable of wireless communication, such as a so-called tablet terminal apparatus or a so-called smartphone that is a personal digital assistant (PDA). Note that the portable device 36G is capable of outputting a print job to another information device.

The third network 36 is of mobile communication, and each information device is connected via a base station disposed in a city. Note that the third network 36 adopts the 4th generation mobile communication system or the 5th generation mobile communication system as an example, and each information device connected to the third network 36 is directly connected to the Internet 30 via the base station. Further, each information device connected to the third network 36 is connected to the Internet 30 by the IPv6 method, and as will be described later, an IPv6 address is individually assigned to each information device as viewed from the Internet 30. The IPv6 address is assigned to each information device by a provider (Internet service provider: ISP) providing the third network 36.

The fourth network 38 is a network to which information devices including a fifth printer 38H, a first laptop 381, and a second laptop 38J are connected. The fifth printer 38H is an information device that, when a print job is received from another information device including the first laptop 381 and the second laptop 38J, prints an image in accordance with the print job.

The fourth network 38 is also a LAN to which a plurality of information devices are connected, and each information device is connected via a router (not illustrated) constituting the LAN. Note that the fourth network 38 adopts the PPPoE method, and each information device connected to the fourth network 38 is indirectly connected to the Internet 30 via the router. Further, each information device connected to the fourth network 38 is connected by the IPv4 method, and only the IP address of the router can be referred to from the Internet 30. Further, an IP address is individually assigned to each information device connected to the fourth network 38 inside the fourth network 38.

Note that the fourth network 38 is a network to which a plurality of users who belong to different groups, such as a so-called co-working space and a shared office, are connected. In the present description, the fourth network 38 is provided by a business operator different from the owners of the first laptop 381 and the second laptop 38J. Further, the fifth printer 38H is an information device disposed by the provider of the fourth network 38, and the owner of the fifth printer 38H is different from those of the first laptop 381 and the second laptop 38J.

Note that, in the following description, the provider of the fourth network 38 is referred to as “GHI company”. Further, as illustrated in FIG. 1, the first laptop 381 is owned by ABC company, and the second laptop 38J is owned by DEF company. Further, the fifth printer 38H is owned by GHI company.

### Authentication Servers

The first authentication server 40A is a server that provides an authentication ticket (electronic authentication) when each information device owned by ABC company uses a network service requiring authentication. For example, when each information device owned by ABC company secretly communicates with a server (not illustrated), the information device requests an authentication ticket from the first authentication server 40A in advance and receives the authentication ticket from the first authentication server 40A. Then, the server (not illustrated) confirms the authentication ticket provided from the first authentication server 40A, thereby enabling secret communication. Note that the first authentication server 40A is an authentication server 40 owned by ABC company.

Similarly to the first authentication server 40A, the second authentication server 40B is a server that provides an authentication ticket (electronic authentication) when each information device owned by DEF company uses a network service requiring authentication. However, the second authentication server 40B is an authentication server 40 owned by XYZ company different from DEF company. In other words, XYZ company is a business operator that provides an authentication service by the second authentication server 40B.

Note that, in the following description, when the first authentication server 40A and the second authentication server 40B are not distinguished from each other, they are simply referred to as the authentication servers 40.

### Cloud Server

The cloud server 20 includes a processor 22 and a recording unit 24. The processor 22 is an example of a device that executes a program recorded in the recording unit 24. For example, a central processing unit (CPU) is used for the processor. The recording unit 24 includes a storage device such as a hard disk drive (HDD), a solid-state drive (SSD), or a flash memory, and stores various programs and various kinds of data. The processor 22 executes a procedure to be described later based on a program recorded in the recording unit 24.

Note that, as will be described later, the cloud server 20 according to the present exemplary embodiment records address information of each information device included in the network system 10 in the recording unit 24. When any information device of the network system 10 requests the address information of another information device, the cloud server 20 compares the owner of the information device requesting the address information with the owner of the information device for which the address information is requested. Then, when the owner of the information device requesting the address information is the same as the owner of the information device for which the address information is requested, the cloud server 20 provides the address information. On the other hand, when the owner of the information device requesting the address information is different from the owner of the information device for which the address information is requested, the cloud server 20 does not provide the address information.

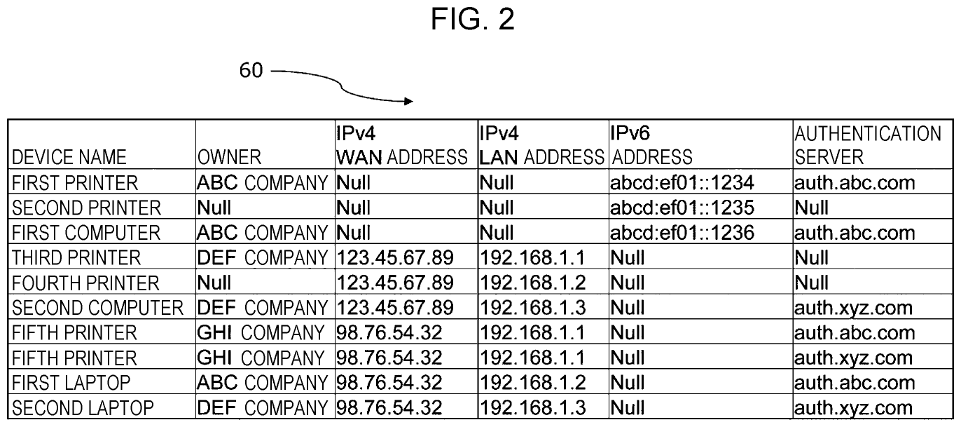

Note that, as illustrated in FIG. 2 and the like to be described later, address information refers to information including a network address in each information device. Specifically, information such as the device name of an information device and the owner of an information device is associated with a network address and recorded in the recording unit 24. Note that, as illustrated in each exemplary embodiment to be described later, information and items that can be included in the address information may be different from each other.

### Information Device List Table

FIG. 2 is a diagram illustrating an example of an information device list table 60 recorded in the recording unit 24 according to the present exemplary embodiment. The information device list table 60 according to the present exemplary embodiment is a table including items (columns) of “device name”, “owner”, “IPv4 WAN address”, “IPv4 LAN address”, “IPv6 address”, and “authentication server” as an example. When each information device communicates with the cloud server 20, the information (value) of each item of the information device is recorded in the information device list table 60.

For example, a case is assumed in which the first printer 32A communicates with the cloud server 20 in a state where the device name, the owner, and the address of the authentication server 40 are recorded in a built-in storage unit (not illustrated) of the first printer 32A. In this case, as illustrated in FIG. 2, in the information device list table 60, the name of the first printer 32A is recorded for “device name” and the name of ABC company is recorded for “owner”, as the information of the first printer 32A. Further, in the information device list table 60, the address of the first authentication server 40A used by the first printer 32A is recorded for “authentication server”, and the address of the first printer 32A when the first printer 32A communicates with the cloud server 20 is recorded for “IPv6 address”.

Note that, since the first printer 32A is connected to the first network 32 and the Internet 30 by the IPv6 method, the first printer 32A does not have an IPv4 address. Therefore, as illustrated in FIG. 2, it is recorded in the information device list table 60 that the values of the items of “IPv4 WAN address” and “IPv4 LAN address” of the first printer 32A are unentered (“Null”).

Further, for other information devices, information which the information devices do not have is not recorded in the information device list table 60. For example, FIG. 2 illustrates that the owner is not recorded in a built-in storage unit (not illustrated) of the second printer 32B and the value of the item of “owner” of the second printer 32B is unentered. In other words, the cloud server 20 according to the present exemplary embodiment allows an unentered value or an empty value to be recorded in the information device list table 60.

Note that there is a case in which a plurality of pieces of address information of the same information device are recorded in the information device list table 60. For example, in FIG. 2, two pieces of address information of the fifth printer 38H are recorded. The first piece of address information of the fifth printer 38H is for a case where the address information of the fifth printer 38H is recorded in the recording unit 24 in a state where the first laptop 381 has transmitted a print job to the fifth printer 38H and the information of the first authentication server 40A is stored in the fifth printer 38H. Further, the second piece of address information of the fifth printer 38H is for a case where the address information of the fifth printer 38H is recorded in the recording unit 24 in a state where the second laptop 38J has transmitted a print job to the fifth printer 38H and the information of the second authentication server 40B is stored in the fifth printer 38H.

### Search for Usable Information Devices

Here, in such network system 10 as illustrated in FIG. 1, the portable device 36G is disposed in a network different from the first network 32. Therefore, when a user using the portable device 36G performs printing by using an information device connected to the first network 32, the portable device 36G cannot request the addresses of the first printer 32A and the second printer 32B from the router or the like of the first network 32. That is, when the connected network is different, the portable device 36G cannot use the information device of which the owner is the same.

### Procedure of Search for Address Information and Returning Operation According to Comparative Example

Here, as a method of searching for address information according to a comparative example, a case is assumed where the portable device 36G makes an inquiry to the cloud server 20 about the address information of information devices of which owner is “ABC company” based on the information device list table 60 illustrated in FIG. 2.

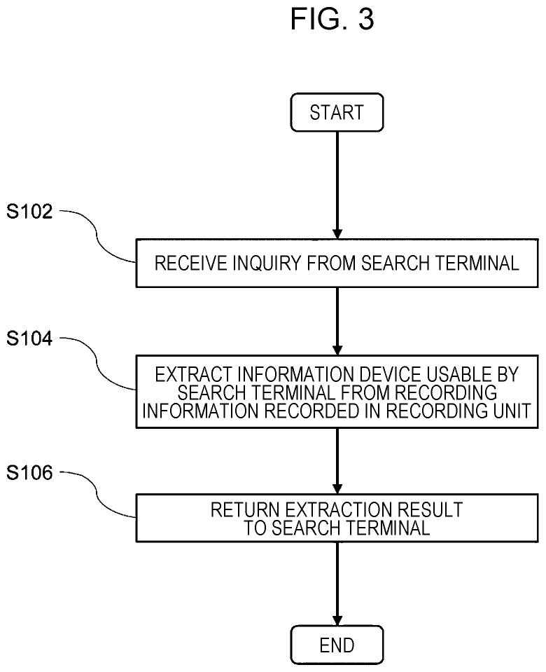

FIG. 3 is a flowchart illustrating an operation procedure of the cloud server 20. As an example, when the processor 22 of the cloud server 20 receives an inquiry from a search terminal, the processor extracts and returns address information.

First, in step S102, the processor 22 receives an inquiry from a search terminal. More specifically, the processor 22 receives a request to extract the address information of an information device for which the value of the item of “owner” is “ABC company” from the portable device 36G, which is a search terminal. Then, the processor 22 proceeds to step S104.

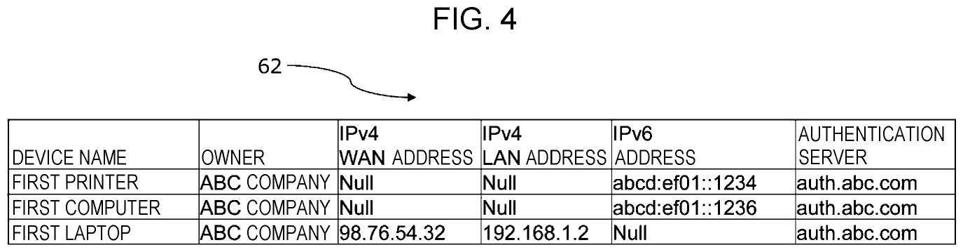

Next, in step S104, the processor 22 extracts information devices usable by the search terminal from the recording information recorded in the recording unit 24. More specifically, as illustrated in FIG. 2, the processor 22 extracts the rows of information devices for which the value of the item of “owner” is “ABC company”, which is the same as the owner of the portable device 36G, from the information device list table 60, and creates a first affiliation information extraction result table 62 as illustrated in FIG. 4. Then, the processor 22 proceeds to step S106.

Next, in step S106, the processor 22 returns an extraction result to the search terminal. More specifically, the processor 22 provides the portable device 36G with the first affiliation information extraction result table 62 illustrated in FIG. 4. Then, the processor 22 ends the returning operation.

In this way, when the cloud server 20 extracts the information devices for which the value of the item of “owner” is “ABC company” described in the information device list table 60 illustrated in FIG. 2, the first affiliation information extraction result table 62 is created as illustrated in FIG. 4. Then, the cloud server 20 provides the portable device 36G with the first affiliation information extraction result table 62, and the portable device 36G communicates with the first printer 32A included in the first affiliation information extraction result table 62.

However, when the cloud server 20 extracts only the information devices for which the value of the item of “owner” is “ABC company”, the second printer 32B for which the item of “owner” is unentered in FIG. 2 is not extracted. Therefore, as illustrated in FIG. 4, since the cloud server 20 provides the portable device 36G with a result in which the second printer 32B is missing, the portable device 36G cannot use the second printer 32B.

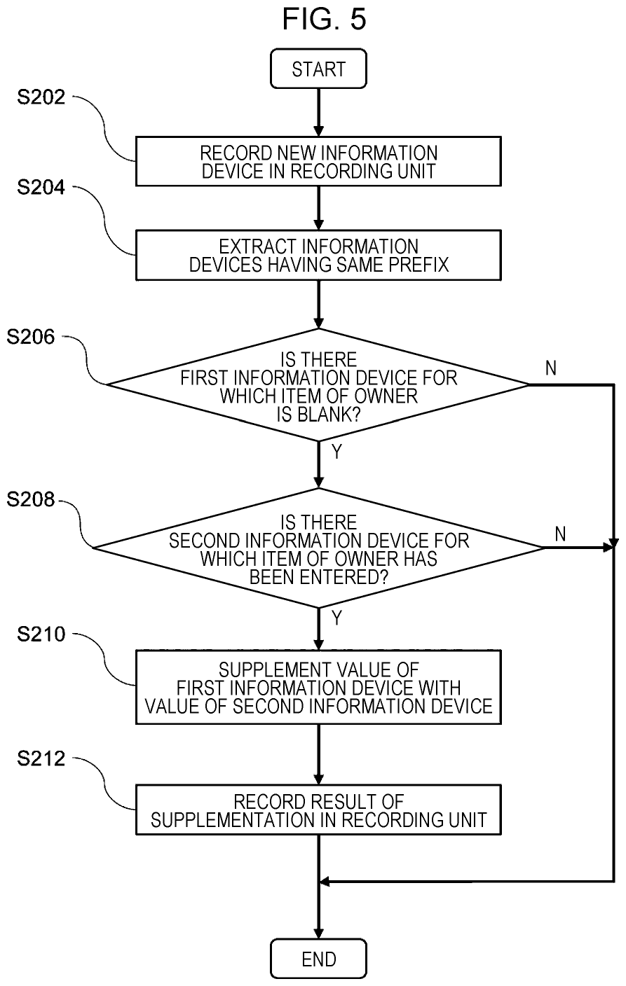

Next, a procedure of a supplementing operation of the cloud server 20 according to the present exemplary embodiment will be described with reference to FIGS. 5 to 8.

### Supplementing Operation and Update Operation

FIG. 5 is a flowchart illustrating an operation procedure of the cloud server 20 according to the present exemplary embodiment. As an example, when a new information device is connected to the network system 10 and the information device communicates with the cloud server 20, the processor 22 of the cloud server 20 according to the present exemplary embodiment supplements the address information of information devices recorded in the recording unit 24 by executing the procedure illustrated in FIG. 5.

First, in step S202, the processor 22 records a new information device in the recording unit 24. In other words, a new row (address information of the new information device) is added to the information device list table 60. Then, the processor 22 proceeds to step S204.

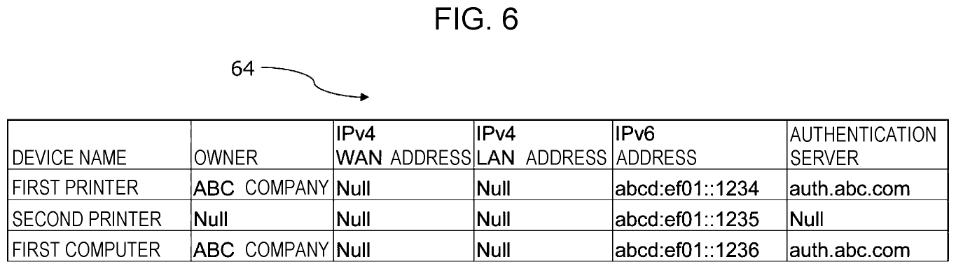

Next, in step S204, as illustrated in FIG. 6, the processor 22 extracts information devices having the same prefix from the address information of the information devices recorded in the information device list table 60. More specifically, the processor 22 extracts information devices for which the value of the IPv6 address starts with “abcd:ef01” from the information device list table 60 illustrated in FIG. 2, and creates a second affiliation information extraction result table 64 illustrated in FIG. 6. Then, the processor 22 proceeds to step S206. Note that the value of the IPv6 address to be extracted may be set by the user of the portable device 36G in any manner.

Next, in step S206, the processor 22 checks whether there is an information device for which the item of “owner” is unentered (“Null”) in the second affiliation information extraction result table 64, as a first information device. Then, when an affirmative determination is made in step S206, the processor 22 proceeds to step S208. On the other hand, when a negative determination is made in step S206, the processor 22 ends the supplementing operation. In FIG. 6, since the item of “owner” is unentered for the second printer 32B, the second printer 32B corresponds to the first information device.

Next, in step S208, the processor 22 checks whether there is an information device for which the item of “owner” has been entered (value other than “Null”) in the second affiliation information extraction result table 64, as a second information device. Then, when an affirmative determination is made in step S208, the processor 22 proceeds to step S210. On the other hand, when a negative determination is made in step S208, the processor 22 ends the supplementing operation. In FIG. 6, since ABC company is recorded as the item of “owner” for the first printer 32A, the first printer 32A corresponds to the second information device.

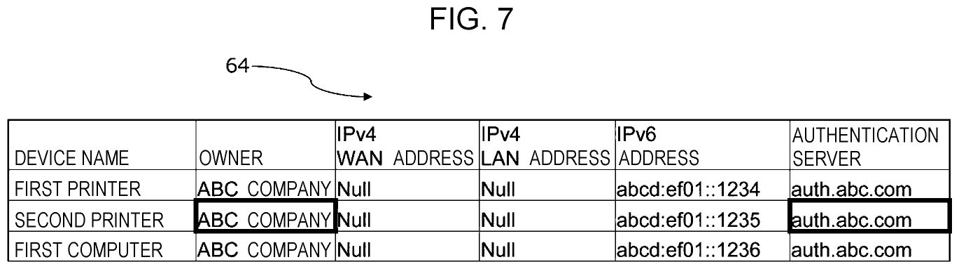

Next, in step S210, the processor 22 supplements the value of a blank item among the items for the first information device with the value of the corresponding item for the second information device. More specifically, as illustrated in FIG. 7, entries are made so that the values of the items of “owner” and “authentication server” for the second printer 32B are the same as the values in the first printer 32A. Then, after the supplementation, the processor 22 proceeds to step S212.

Next, in step S212, the processor 22 records the result of supplementation in step S210 in the recording unit 24. More specifically, the processor 22 updates the information device list table 60 recorded in the recording unit 24 with the address information of the second printer 32B supplemented in step S210. Thereafter, the processor 22 ends the supplementing operation.

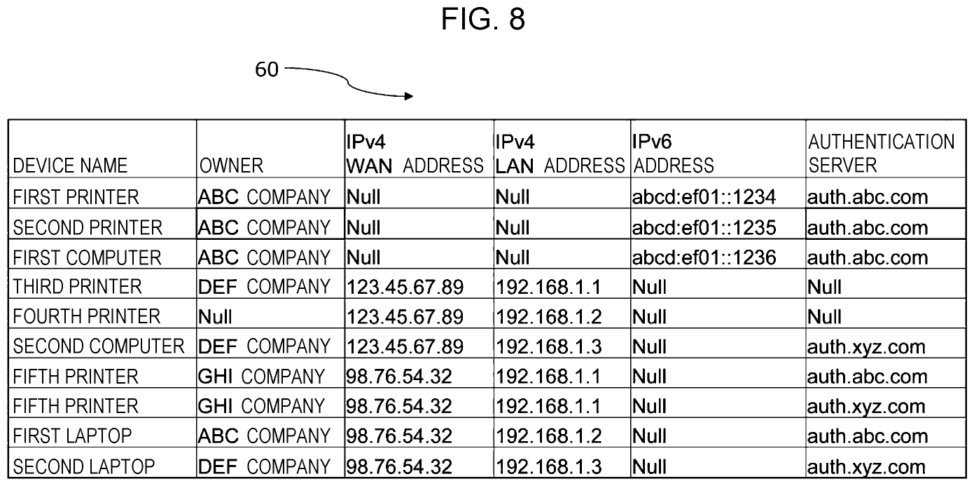

Then, the processor 22 records the address information of the second printer 32B in the recording unit 24, thereby supplementing the address information of the second printer 32B and updating the information device list table 60 as illustrated in FIG. 8.

### Result of Returning Operation after Supplementation

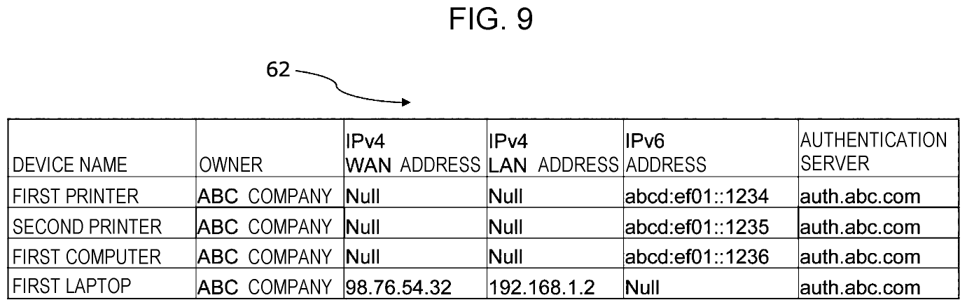

Then, when the processor 22 extracts, after the above-described supplementing operation and update operation, information devices of which the owner is the same as the owner of the portable device 36G by a procedure similar to FIG. 3, the second printer 32B is included in the created first affiliation information extraction result table 62 as illustrated in FIG. 9. The processor 22 according to the present exemplary embodiment provides the portable device 36G with the first affiliation information extraction result table 62 illustrated in FIG. 9.

In the present exemplary embodiment, after supplementation of address information in accordance with the above-described procedure, the portable device 36G is provided with the address information of information devices of which the owner is the same as that of the portable device 36G. In other words, the processor 22 enables the portable device 36G to refer to the second printer 32B. That is, in the present exemplary embodiment, the item of “owner” is an example of “first affiliation information”, and the fact that the item of “owner” is unentered is an example of “no first affiliation information”. Further, in the present exemplary embodiment, the prefix of the IPv6 address (more specifically, “abcd:ef0l”) is an example of “second affiliation information”. Further, in the present exemplary embodiment, the portable device 36G is an example of “search terminal”, and the first printer 32A of which the owner is the same as that of the portable device 36G is an example of “information device usable by the search terminal”.

Next, the operation and effect of the present exemplary embodiment will be described.

### Operation and Effect

The network system 10 of the present exemplary embodiment includes the recording unit 24 that is disposed on a network and in which recording information including the address information, an item of “owner”, and a prefix of an IPv6 address of a plurality of information devices is recorded, and the processor 22. Further, when an inquiry about information devices usable by the portable device 36G is received from the portable device 36G, the processor 22 performs a returning operation of extracting, from the recording unit 24, the address information of information devices for which the value of the item of “owner” is the same as that for the portable device 36G, and returning the address information. Further, the processor 22 executes, for the second printer 32B for which there is no value of the item of “owner” in the recording information, a supplementing operation of supplementing the recording information of the second printer 32B with the value of the item of “owner” based on the recording information of the first printer 32A for which the prefix of the IPv6 address is the same as that for the second printer 32B. Then, in the returning operation, the processor 22 extracts the address information of information devices having the same value of the item of “owner” based on the information of the recording unit 24 reflecting the result of supplementation by the supplementing operation, and returns the address information.

Thus, according to the network system 10 according to the present exemplary embodiment, the second printer 32B for which the value of the item of “owner” is unentered in the recording information can be referred to by the portable device 36G of which the owner is the same.

Further, in the network system 10 of the present exemplary embodiment, network information includes a prefix of an IPv6 address. Thus, according to the network system 10 according to the present exemplary embodiment, the portable device 36G may use an information device having the same prefix of the IPv6 address for which the item of “owner” is unentered.

Further, in the network system 10 of the present exemplary embodiment, the supplementing operation is executed when the recording unit 24 receives recording processing of recording the recording information of an information device. Thus, according to the network system 10 according to the present exemplary embodiment, return of address information to the portable device 36G is quicker compared to a case where the supplementing operation is executed when an inquiry is received from the portable device 36G.

Note that, in the above description, the prefix of the IPv6 address is used as the network information of an information device, but the technique according to the present exemplary embodiment is not limited to this case. For example, an IPv4 WAN address, a subnet mask, or the like may be used as the network information.

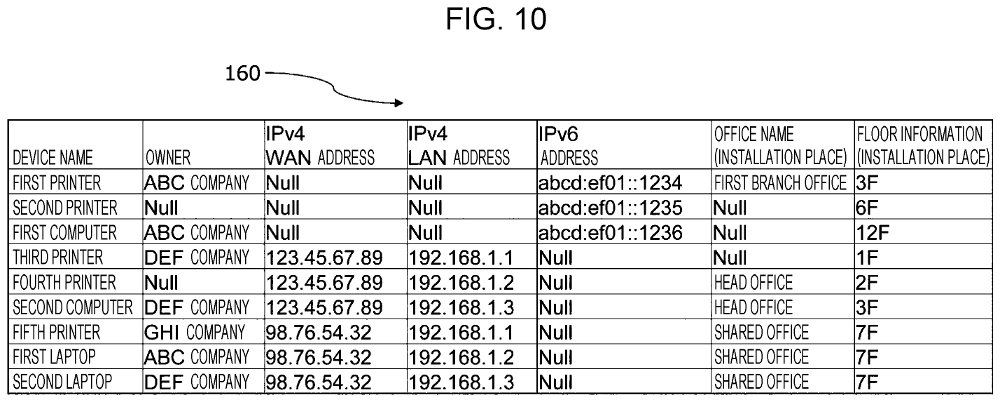

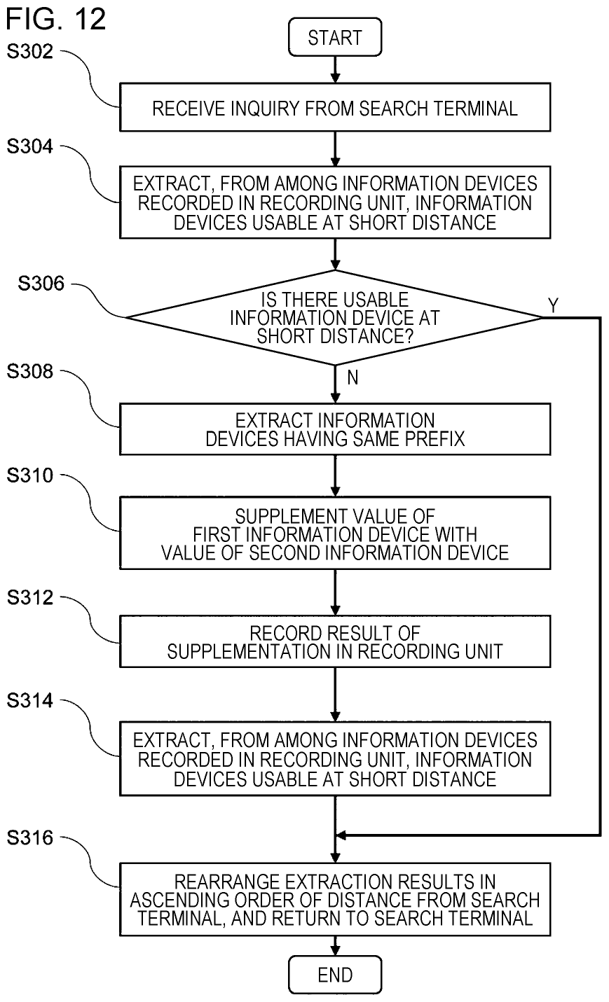

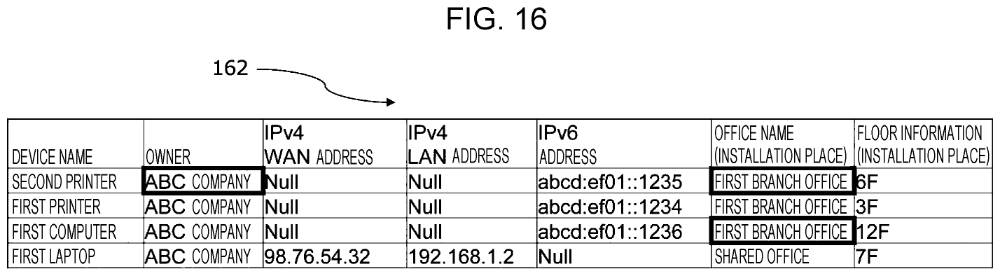

Next, a network system 10 according to a second exemplary embodiment of the present disclosure will be described with reference to FIGS. 10 to 16 as appropriate.

### Second Exemplary Embodiment

### Configuration

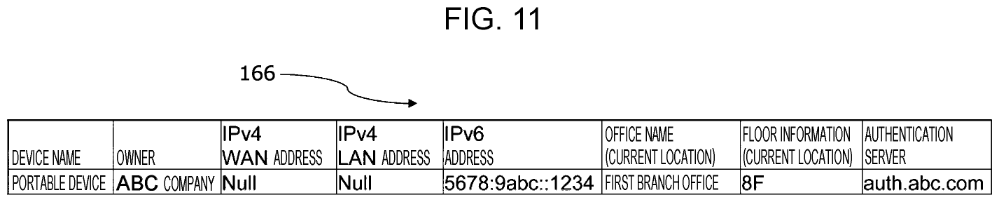

The main device configuration of the network system 10 according to the present exemplary embodiment is similar to that in the first exemplary embodiment. However, in the present exemplary embodiment, as illustrated in FIGS. 10 and 11, in an information device list table 160, items of “office name” and “floor information” are added to the information device list table 60 according to the first exemplary embodiment.

Note that, in the present exemplary embodiment, “office name” and “floor information” are recorded in each information device when the owner of the information device inputs them to the information device. Further, conditions for recording the address information of each information device in the recording unit 24 are similar to those in the first exemplary embodiment, and when the address information of each information device is recorded, the values of “office name” and “floor information” for the information device are recorded in the recording unit 24.

In the present exemplary embodiment, a case is assumed in which a user performs printing using the portable device 36G connected to the third network 36 and a printer close to the portable device 36G. Note that, in the description of the present exemplary embodiment, being close to the portable device 36G means that the office name of the place where the printer is installed is “first branch office”, which is the same as that for the portable device 36G, and the floor where the printer is installed is not three or more floors away from the portable device 36G, that is, “5F” to “11F”. A procedure of searching for usable information devices and a procedure of supplementation according to the present exemplary embodiment will be described with reference to FIGS. 11 to 16.

### Search for Usable Information Devices

First, in step S302, the processor 22 receives an inquiry about usable information devices from the portable device 36G, which is a search terminal. More specifically, as illustrated in FIG. 11, the portable device 36G transmits, to the cloud server 20, a search terminal information table 166 including data in which “office name” and “floor information” are entered. Then, the processor 22 receives the search terminal information table 166 transmitted from the portable device 36G, and proceeds to step S304.

Next, in step S304, the processor 22 extracts, from among the information devices recorded in the recording unit 24, information devices usable at a short distance. More specifically, the processor 22 extracts, from the information device list table 160 recorded in the recording unit 24, information devices for which “office name” is the same as that for the portable device 36G and “floor information” is not three or more floors away from the portable device 36G. Then, the processor 22 proceeds to step S306.

Next, in step S306, the processor 22 checks whether an information device has been extracted in step S304. Then, when an affirmative determination is made in step S306, the processor 22 proceeds to step S316. On the other hand, when a negative determination is made in step S306, the processor 22 proceeds to step S308. More specifically, as illustrated in FIG. 10, since the information device list table 160 does not include an information device for which “office name” is the same as that for the portable device 36G and “floor information” is not three or more floors away from the portable device 36G, the processor 22 makes a negative determination in step S306.

### Supplementing Operation

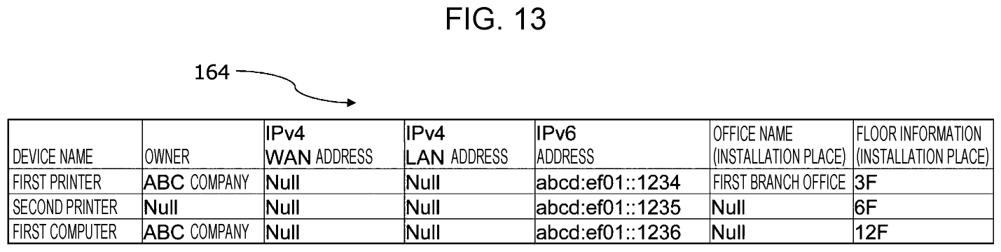

Next, in step S308, the processor 22 extracts, from the pieces of address information of the information devices recorded in the information device list table 160, information devices having the same prefix. More specifically, the processor 22 extracts, from the information device list table 160 illustrated in FIG. 10, a list of information devices for which the value of the IPv6 address starts with “abcd:ef01”, and creates a second affiliation information extraction result table 164 illustrated in FIG. 13. Then, the processor 22 proceeds to step S310. Note that the value of the IPv6 address to be extracted may be set by the user of the portable device 36G in any manner.

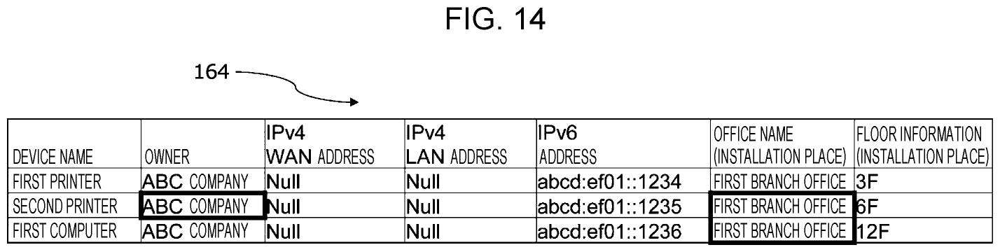

Next, in step S310, the processor 22 supplements the value of a blank item among the items for a first information device with the value of a corresponding item for a second information device. More specifically, as illustrated in FIG. 14, the values of “owner” and “office name” for the second printer 32B are entered so as to be the same values as those for the first printer 32A. Then, after the supplementation, the processor 22 proceeds to step S312. Note that, in FIG. 14, since the items of “owner” and “office name” are unentered for the second printer 32B, the second printer 32B corresponds to the first information device. Further, since the items of “owner” and “office name” are recorded for the first printer 32A, the first printer 32A corresponds to the second information device.

Next, in step S312, the processor 22 records the result of supplementation in step S310 in the recording unit 24. More specifically, the processor 22 updates the information device list table 160 recorded in the recording unit 24 with the address information of the second printer 32B supplemented in step S310. Then, after the recording, the processor 22 proceeds to step S314.

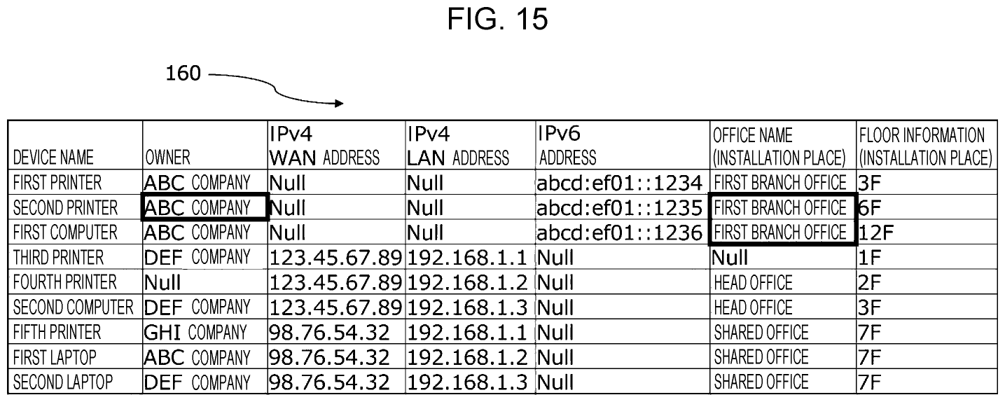

Next, in step S314, the processor 22 extracts again, from among the information devices recorded in the recording unit 24, information devices usable at a short distance. More specifically, as illustrated in FIG. 15, the processor 22 extracts, from the information device list table 160, information devices for which “office name” is the same as that for the portable device 36G and “floor information” is not three or more floors away from the portable device 36G. Then, the processor 22 creates a first affiliation information extraction result table 162, which is a result of the extraction, and proceeds to step S316.

### Ranking Operation and Returning Operation

Then, in step S316, the processor 22 according to the present exemplary embodiment ranks the extraction results based on the distances from the search terminal, and then returns the extraction results to the search terminal. More specifically, the processor 22 rearranges the rows of the first affiliation information extraction result table 162 such that the values of “floor information” are in ascending order of distance from “8F”, which is the floor information of the portable device 36G, and then provides the portable device 36G with the first affiliation information extraction result table 162.

In the present exemplary embodiment, in accordance with the above-described procedure, the portable device 36G is provided with the address information of information devices usable at a short distance. That is, in the present exemplary embodiment, the items of “owner” and position information (more specifically, “office name”) are examples of “first affiliation information”, and the fact that the items of “owner” and “office name” are unentered is an example of “no first affiliation information”. Further, in the present exemplary embodiment, the prefix of the IPv6 address (more specifically, “abcd:ef0l”) is an example of “second affiliation information”. Further, in the present exemplary embodiment, the portable device 36G is an example of “search terminal”, and the printer close to the portable device 36G (more specifically, not three or more floors away from the portable device 36G) is an example of “information device usable by the search terminal”.

Next, the operation and effect of the present exemplary embodiment will be described.

In the network system 10 according to the present exemplary embodiment, first affiliation information includes position information of an information device. Thus, according to the network system 10 according to the present exemplary embodiment, the portable device 36G can use the second printer 32B that is nearby.

Further, in the network system 10 according to the present exemplary embodiment, the returning operation includes a ranking operation of ranking the extracted pieces of address information based on a specified condition. Thus, according to the network system 10 according to the present exemplary embodiment, the portable device 36G receives the return of the pieces of address information ranked based on the specified condition.

Further, in the network system 10 according to the present exemplary embodiment, the specified condition is a distance with respect to the floor information of the portable device 36G. Thus, according to the network system 10 according to the present exemplary embodiment, the portable device 36G receives return of the address information of the second printer 32B close to the portable device 36G, and the user may use the closer printer.

Further, in the network system 10 according to the present exemplary embodiment, the supplementing operation is executed when an inquiry is received from the portable device 36G. Thus, according to the network system 10 according to the present exemplary embodiment, the cost of the supplementing operation for an information device having the first affiliation information different from that of the portable device 36G is lower compared to a case where the supplementing operation is executed when recording processing is received.

Further, in the network system 10 according to the present exemplary embodiment, the supplementing operation is executed when the processor 22 cannot extract an information device having the same first affiliation information as that of the portable device 36G from the information of the recording unit 24. Thus, according to the network system 10 according to the present exemplary embodiment, return of address information to the portable device 36G is quicker compared to a case where the supplementing operation is executed every time when an inquiry is received from the portable device 36G.

Note that, also in the present exemplary embodiment, those having a configuration similar to that in the first exemplary embodiment can obtain functions and effects similar to those in the first exemplary embodiment.

Note that, in the above description, the office name and the floor information are used as position information of an information device, but the technique according to the present exemplary embodiment is not limited to this case. For example, an address, positioning information by a global positioning system (GPS), or the like may be used as position information.

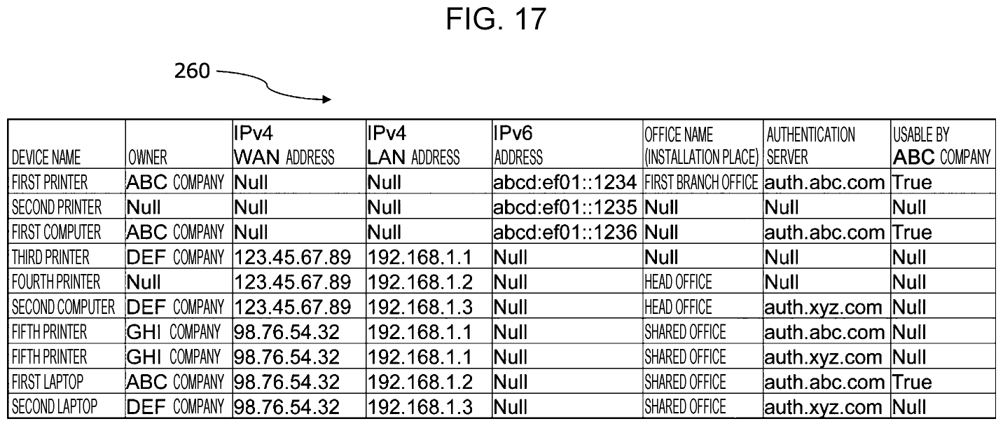

Next, a network system 10 according to a third exemplary embodiment of the present disclosure will be described with reference to FIGS. 17 to 19 as appropriate.

### Third Exemplary Embodiment

### Configuration

The main device configuration of the network system 10 according to the present exemplary embodiment is similar to that in the first exemplary embodiment.

In the present exemplary embodiment, a case is assumed in which a user performs printing using the portable device 36G connected to the third network 36 and a printer installed in a shared office. Note that, in the description of the present exemplary embodiment, usable by the portable device 36G indicates that a printer is usable by ABC company, which is the owner of the portable device 36G, and is installed in a shared office, and a positional relationship with the portable device 36G is not taken into consideration.

Further, as illustrated in FIG. 17, in the present exemplary embodiment, the item of “usable by ABC company” is provided in an information device list table 260. This item is an item that is newly provided after the information device list table 60 illustrated in FIG. 2 is created in the network system 10 illustrated in FIG. 1, and the value of “True” is entered for a device that is usable by ABC company.

Note that, as illustrated in FIG. 17, for information devices for which the value of the item of “owner” is “ABC company” at the time when the item of “usable by ABC company” is provided, the value of “True” is unconditionally entered as the item of “usable by ABC company”. On the other hand, for information devices for which the value of the item of “owner” is not “ABC company”, the value of unentered “Null” is entered as the item of “usable by ABC company”.

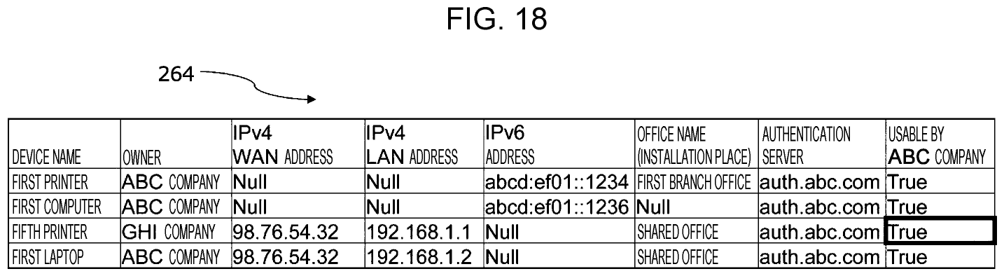

Next, a procedure of a supplementing operation and a procedure of a returning operation of usable information devices according to the present exemplary embodiment will be described with reference to FIGS. 17 and 18.

### Supplementing Operation and Update of Information Device List Table

In the procedure of the supplementing operation, the processor 22 in the present exemplary embodiment extracts information devices that have used the authentication server 40 of ABC company. In other words, in the present exemplary embodiment, in step S204 in FIG. 5, the processor 22 extracts information devices for which “auth.abc.com” is entered as “authentication server” instead of information devices “having the same prefix”, and creates a second affiliation information extraction result table 264.

Further, in the procedure of the supplementing operation, the processor 22 in the present exemplary embodiment supplements the value of an information device for which “True” is not entered as the item of “usable by ABC company” with the value of an information device for which “True” is entered as the item of “usable by ABC company” in the second affiliation information extraction result table 264. In other words, the processor 22 in the present exemplary embodiment rewrites, to “True”, the value of an information device for which “True” is not entered as the item of “usable by ABC company” in the second affiliation information extraction result table 264. Thus, as illustrated in FIG. 18, “True” is entered as the item of “usable by ABC company” also for the fifth printer 38H disposed in a shared office.

Other procedures of the supplementing operation of information devices are similar to those in the first exemplary embodiment. Further, as in the first exemplary embodiment, the information device list table 260 is also updated.

### Returning Operation

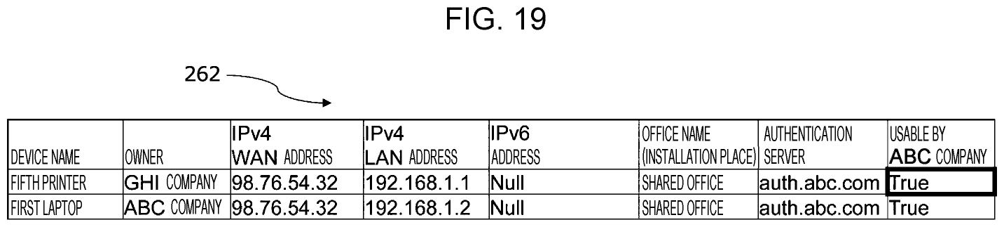

Then, the processor 22 according to the present exemplary embodiment extracts information devices of which the owner is the same as the owner of the portable device 36G by a procedure similar to FIG. 3. Further, the processor 22 according to the present exemplary embodiment further performs an operation of re-extracting information devices for which “office name” is “shared office”. Then, the processor 22 of the cloud server 20 provides the portable device 36G with a first affiliation information extraction result table 262 illustrated in FIG. 19. Note that other procedures of the returning operation of information devices are similar to those in the first exemplary embodiment.

In the present exemplary embodiment, in accordance with the above-described procedure, the portable device 36G is provided with the address information of information devices usable by ABC company and installed in a shared office. That is, in the present exemplary embodiment, the item of “usable by ABC company” is an example of “first affiliation information”, and the fact that the item of “owner” is unentered is an example of “no first affiliation information”. Further, in the present exemplary embodiment, the authentication server 40 is an example of “second affiliation information”. Further, in the present exemplary embodiment, the portable device 36G is an example of “search terminal”, and the fifth printer 38H for which the item of “usable by ABC company” is True and which is installed in a shared office is an example of “information device usable by the search terminal”. Further, in the present exemplary embodiment, the fact that shared office is entered as the item of “office name” is an example of “satisfying a specified condition”.

Next, the operation and effect of the present exemplary embodiment will be described.

In the network system 10 of the present exemplary embodiment, second affiliation information includes the name of the authentication server 40 that authenticates an information device. Therefore, in the network system 10 according to the present exemplary embodiment, the portable device 36G may use the fifth printer 38H which uses the same authentication server 40 and for which the item of “owner” is unentered.

Further, in the network system 10 of the present exemplary embodiment, the returning operation includes an operation of re-extracting address information that satisfies a specified condition from the extracted pieces of address information. Thus, according to the network system 10 according to the present exemplary embodiment, the portable device 36G receives return of the address information of the fifth printer 38H for which shared office is entered as the item of “office name”.

Note that, also in the present exemplary embodiment, those having a configuration similar to that in the first exemplary embodiment or the second exemplary embodiment can obtain functions and effects similar to those in the first exemplary embodiment or the second exemplary embodiment.

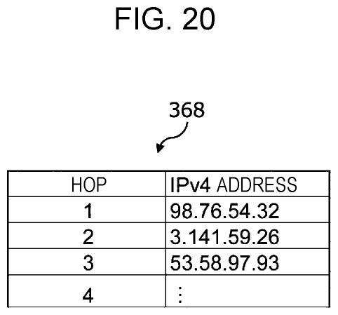

Next, a network system 10 according to a fourth exemplary embodiment of the present disclosure will be described with reference to FIG. 20 as appropriate.

### Fourth Exemplary Embodiment

The main device configuration of the network system 10 according to the present exemplary embodiment is similar to that in the first exemplary embodiment. However, in the present exemplary embodiment, as illustrated in FIG. 20, in the recording unit 24, an access route table 368 is recorded which includes a result of usage of a device such as a router connected to a network for each information device to reach the cloud server 20. More specifically, in the access route table 368, the address of each device corresponding to a route connected from each information device to another network via a device such as a router is recorded. For example, FIG. 20 illustrates the addresses of the first three information devices out of the access routes from an information device to the cloud server 20. Note that the access route table 368 may be recorded in any manner in the recording unit 24 as long as it is associated with the address information of each information device.

### Supplementing Operation, Extracting Operation, and Returning Operation

In the procedure of a supplementing operation, the processor 22 in the present exemplary embodiment extracts, from the access route table 368, information devices having the same predetermined route. In other words, in the present exemplary embodiment, in step S204 in FIG. 5, the processor 22 extracts, from the access route table 368, information devices for which a predetermined route is entered, instead of information devices “having the same prefix”, and creates the second affiliation information extraction result table 64.

Note that other operations are similar to those in the first to third exemplary embodiments. That is, in the present exemplary embodiment, the access route is an example of “second affiliation information”.

In the network system 10 of the present exemplary embodiment, second affiliation information includes access route information from a network to an information device. Thus, according to the network system 10 according to the present exemplary embodiment, a search terminal may use an information device which has the same access route information and for which there is no first affiliation information.

Note that, also in the present exemplary embodiment, those having a configuration similar to that in the first to third exemplary embodiments can obtain functions and effects similar to those in the first to third exemplary embodiments.

### Other Modifications

In the above description, the processor 22 creates the second affiliation information extraction result table 64 from the information device list table 60 recorded in the recording unit 24 after an inquiry about address information is received from a search terminal. However, the technique according to the present disclosure is not limited to this case. For example, the processor 22 may create the second affiliation information extraction result table 64 in advance before an inquiry is received from a search terminal. Further, the processor 22 may perform the supplementing operation for the second affiliation information extraction result table 64 before an inquiry is received from a search terminal.

Further, in the above description, information devices having the same second affiliation information are supplemented with first affiliation information without particular limitation. However, the technique according to the present disclosure is not limited to this case. For example, first prohibition information that prohibits the processor 22 from supplementation with first affiliation information may be allowed to be added to the address information of each information device.

Further, in the above description, for information devices having the same second affiliation information, first affiliation information of a first information device for which there is no first affiliation information is supplemented with a second information device having the first affiliation information without particular limitation. However, the technique according to the present disclosure is not limited to this case. For example, second prohibition information that prohibits the processor 22 from supplementing the first affiliation information of the first information device based on the first affiliation information of the second information device, may be allowed to be added to the address information of the second information device.

In this case, since the first affiliation information is prevented from being supplemented by the processor 22 against the user's expectation, the security of information devices desired to be concealed from a search device can be improved.

Further, in the above description, a result of supplementation is recorded in the recording unit 24 for information devices for which first affiliation information is supplemented. However, the technique according to the present disclosure is not limited to this case. For example, the processor 22 may delete, in accordance with a predetermined condition, a first affiliation information result of information devices for which first affiliation information is supplemented. The predetermined condition includes a case where a predetermined time has elapsed for a period during which an information device is not included in the first affiliation information extraction result table 62 (not a search target of a search terminal) from when the supplementing operation is executed.

Note that, in the above description, the cloud server 20 is connected to a network different from the plurality of small-scale networks including the first network 32. However, the technique according to the present disclosure is not limited to this case. The technique according to the present disclosure is applicable to the cloud server 20 as long as the cloud server 20 is disposed on a network connectable from other information devices. That is, the Internet 30 and the first network 32 to the fourth network 38 are all examples of the network according to the present disclosure.

Further, in the above description, the portable device 36G is mainly used as an example of a search terminal, and the portable device 36G searches for usable information devices. However, the technique according to the present disclosure is not limited to this case. For example, other information devices including the first computer 32C and the second computer 34F are also examples of the search terminal according to the present disclosure.

While the exemplary embodiments of the present disclosure have been described above with reference to the accompanying drawings, it is apparent that those skilled in the art to which the present disclosure pertains can conceive various modifications and applications within the scope of the technical idea described in the claims, and it is to be understood that these naturally belong to the technical scope of the present disclosure.

Note that preferable aspects of the present disclosure are further described below.

(((1)))

A network system comprising:
a recording unit that is disposed on a network and in which recording information that includes address information, first affiliation information, and second affiliation information of a plurality of information devices is recorded; and
a processor configured to:
   execute, when an inquiry about an information device usable by a search terminal is received from the search terminal, a returning operation of extracting address information of the information device that has same first affiliation information as the search terminal from the recording unit and returning the address information; and
   execute a supplementing operation of supplementing, for a first information device for which there is no first affiliation information in recording information, the recording information of the first information device with the first affiliation information based on recording information of a second information device that has same second affiliation information as the first information device, wherein
in the returning operation, the processor is configured to extract address information of an information device that has the same first affiliation information based on information of the recording unit that reflects a result of supplementation by the supplementing operation and returns the address information.
   (((2)))

The network system according to (((1))), wherein the second affiliation information includes network information.

(((3)))

The network system according to (((1))) or (((2))), wherein the second affiliation information includes access route information from a network to an information device.

(((4)))

The network system according to any one of (((1))) to (((3))), wherein the second affiliation information includes a name of an authentication server that authenticates an information device.

(((5)))

The network system according to any one of (((1))) to (((4))), wherein the first affiliation information includes position information of an information device.

(((6)))

The network system according to any one of (((1))) to (((5))), wherein the returning operation includes a ranking operation of ranking the extracted address information based on a specified condition.

(((7)))

The network system according to any one of (((1))) to (((5))), wherein the returning operation includes an operation of re-extracting the address information that satisfies a specified condition from the extracted address information.

(((8)))

The network system according to (((6))) or (((7))), wherein the specified condition is a distance with respect to position information of the search terminal.

(((9)))

The network system according to any one of (((1))) to (((8))), wherein the supplementing operation is executed when the inquiry is received from the search terminal.

(((10)))

The network system according to (((9))), wherein the supplementing operation is executed when the processor cannot extract an information device that has the same first affiliation information from information of the recording unit.

(((11)))

The network system according to any one of (((1))) to (((8))), wherein the supplementing operation is executed when the recording unit receives recording processing of recording information of an information device.

What is claimed is:

1. A network system comprising:
a recording unit that is disposed on a network and in which recording information that includes address information, first affiliation information, and second affiliation information of a plurality of information devices is recorded; and
a processor configured to:
execute, when an inquiry about an information device usable by a search terminal is received from the search terminal, a returning operation of extracting address information of the information device that has same first affiliation information as the search terminal from the recording unit and returning the address information; and
execute a supplementing operation of supplementing, for a first information device for which there is no first affiliation information in recording information, the recording information of the first information device with the first affiliation information based on recording information of a second information device that has same second affiliation information as the first information device, wherein
in the returning operation, the processor is configured to extract address information of an information device that has the same first affiliation information based on information of the recording unit that reflects a result of supplementation by the supplementing operation and returns the address information.

2. The network system according to claim 1, wherein the second affiliation information includes network information.

3. The network system according to claim 1, wherein the second affiliation information includes access route information from a network to an information device.

4. The network system according to claim 1, wherein the second affiliation information includes a name of an authentication server that authenticates an information device.

5. The network system according to claim 1, wherein the first affiliation information includes position information of an information device.

6. The network system according to claim 1, wherein the returning operation includes a ranking operation of ranking the extracted address information based on a specified condition.

7. The network system according to claim 1, wherein the returning operation includes an operation of re-extracting the address information that satisfies a specified condition from the extracted address information.

8. The network system according to claim 6, wherein the specified condition is a distance with respect to position information of the search terminal.

9. The network system according to claim 7, wherein the specified condition is a distance with respect to position information of the search terminal.

10. The network system according to claim 1, wherein the supplementing operation is executed when the inquiry is received from the search terminal.

11. The network system according to claim 10, wherein the supplementing operation is executed when the processor cannot extract an information device that has the same first affiliation information from information of the recording unit.

12. The network system according to claim 1, wherein the supplementing operation is executed when the recording unit receives recording processing of recording information of an information device.
